(19) United States
(12) Patent Application Publication
(10) Pub. No.: US 2011/0222671 A1
(43) Pub. Date: Sep. 15, 2011

(54) PHONE CALL RECORDING DEVICE TO TELEPHONE APPARATUS WITH USB CONNECTION

(76) Inventor: Fernando Ferreira, Sao Paulo (BR)

(21) Appl. No.: 12/673,540

(22) PCT Filed: Aug. 14, 2008
(86) PCT No.: PCT/BR08/00241

§ 371 Date: May 23, 2011

(30) Foreign Application Priority Data
Aug. 14, 2007 (BR) PI 0703489-0

(51) Int. Cl. H04M 1/64

(52) U.S. Cl. 379/67.1

(57) ABSTRACT

Represented by an inventive solution that aggregates value to the telephone apparatus by providing recording, storage, audio and data transmission of phone calls from a single telephone apparatus (A) without the need of being permanently connected to a peripheral device (C), such as a computer, being such device now claimed uses a microprocessor (5) that connected to a telephone interface (7) recognizes the start and the end of the phone call, starting the recording in the flash memory (6), where this memory can store a great volume of recordings, and to recover and hear a recorded call the user should handle on (2a) and (2b) buttons; additionally, according to the user's desire, or whenever the indicator light (8) turns on, the recordings should be transferred from the flash memory (6) to a recording device, through an USB interface (3) connection to a peripheral device (C), such as a computer, for example.

The present demand of patent of invention of the referred title and object of description and claim in this document is related to an inventive solution to voice recording, mainly to record telephone calls, received or sent through telephone apparatus, where such invention is resulting from the identified need of the market of generation of recording of long-period calls.

At its turn, the petitioner has also identified that the inedited device of voice recording has as obligatory requirement the easiness of playing the recorded information, without waste of time.

Another objective of the invention now claimed is the requirement of providing easy reproduction of the information recorded in different peripheral devices of the telephone apparatus, such as last-generation computers (desktop, notebook, laptop and similar), stereo systems and recorder devices with modern connection interfaces, as “USB” interfaces.

Related to its applicability this new device is different since it provides a flexible use, since its development has considered all types of telephony services, and it can be installed in a peripheral way or as a part of the construction of all types of telephone apparatus known in the state of the technique, where among the main characteristics we can mention: telephone apparatus with message recorder device; telephone apparatus with message recorder device and call identification; all call indication devices that are peripheral to the telephone apparatus and also the Head Set-type provided with recorder.

Thus it is conclusive that the phone call recording device to telephone apparatus with option of “USB” connection has the characteristic of innovation, inventive activity and industrial application, accomplishing the patentability requirements, mainly of a patent of invention, according to 8^{th} of Law 9,279 (Lei de Patentes, Marcas e Direitos Conexos), May 14, 1996.

### TECHNICAL BACKGROUND

In order to provide veracity to the context presented in the Introduction section, a brief explanation will be made about the state of the technique of the systems of voice recording to phone calls, received or sent, where it will be possible to a skilled technician to recognize their limitative aspects to present, in a posterior moment, the aggregated advantages with the introduction of the inedited voice recording device.

A study of the solutions known to call recording devices reveals the existence of countless solutions, where basically these have as basic concept that the telephone apparatus has functions allowing the call recording. A critical analysis of theirs functionalities allows listing some restrictive aspects, such as:
Limited time of call recording;
Recording in k7 type;
No reliability of keeping the recorded data;
High cost of the adopted technology;
Low quality of the obtained recording;
Need of adapters to transfer the recorded content in the telephone apparatus to peripheral devices as switches, tape recorders and players of this nature.

There is also a more contemporary solution that allows recording the received phone calls in a telephone apparatus, but it should be necessarily connected to a computer. Additionally, this solution practically requires the use of specific software for storage, transfer and reading of the recorded data.

As we can see, the negative factors above revealed has as foundation the use of obsolete technology to get the recording and playing of these calls in a quick way with quality and reliability, evidencing a gap in the set of solutions to record phone calls, providing space for the creation of improved inventions.

### PROPOSAL OF INVENTION

Considering all exposed in the Technical Background section, the petitioner idealized an inedited phone call recording device to telephone apparatus with USB connection, where it presents different solutions from the state of the technique, by presenting the following characteristics:

a) The recording device can be connected to the telephone apparatus or be integral part of its construction.

b) Distinct high-capacity storage, about 3,800 minutes, without the need of the equipment be connected to a peripheral device, as a computer. Thus, a unique storage capacity is obtained, allowing recording the whole phone call, received and sent;

c) It has an indicator light to indicate the full capacity of recording storage, warning the user to the need of transferring the recorded data to liberate the memory for storing new recordings.

d) Its operation does not require the connection to a peripheral device (e.g., computer), it is to say, to record the calls;

e) The new recording device does not require the installation of specific software for the communication with peripheral devices (e.g., computer), and the files are recorded in “wave” format;

f) It presents a safe way of storage—even if the phone apparatus is turned off and disconnected from an energy source.

### FIGURES DESCRIPTION

In order to complement the current description, and to get a better understanding of the characteristics of the present demand of invention, a set of drawings is attached, where in an exemplified, but not limitative, way a realization form to the phone call recording device to telephone apparatus with USB connection is represented, where:

FIG. 1 is a schematic representation in the form of block diagram of the constructive concept and functionality introduced with the inedited phone call recording device to telephone apparatus with USB connection;

FIG. 2 is a perspective view of the posterior part of a telephone apparatus, indicating an inedited USB interface;

FIG. 3 is a perspective view of the posterior part of a call identifier apparatus, indicating an inedited USB interface; and

FIG. 4 is a plant view of a call identifier apparatus, indicating an inedited USB interface and also revealing its set of buttons and display.

### DETAILED DESCRIPTION

The following detailed description should be read and interpreted with the attached drawings, merely diagrammatic ones, representing a form of favorite realization of the phone call recording device applied to telephone apparatus, not limiting the scope of this invention, which is only limited in the Claims section.

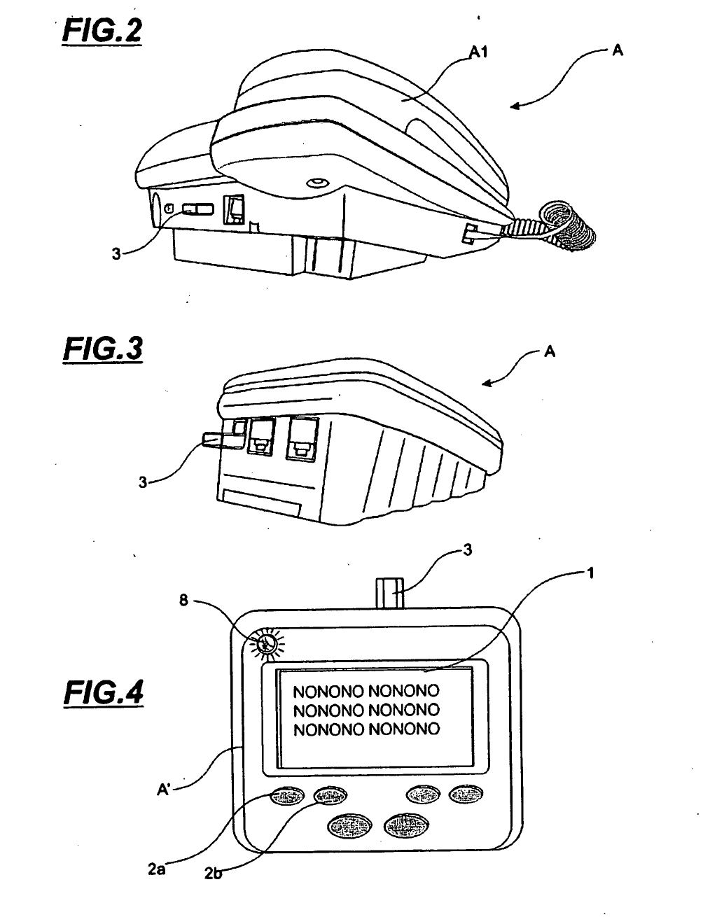

In accordance with the illustrative drawings the present demand of invention is related to a phone call recording device to telephone apparatus with USB connection, which can be applied to several apparatus, mainly to a fixed apparatus (A), such as illustrated in FIG. 2, or, to a call identifier apparatus (A′), respectively.

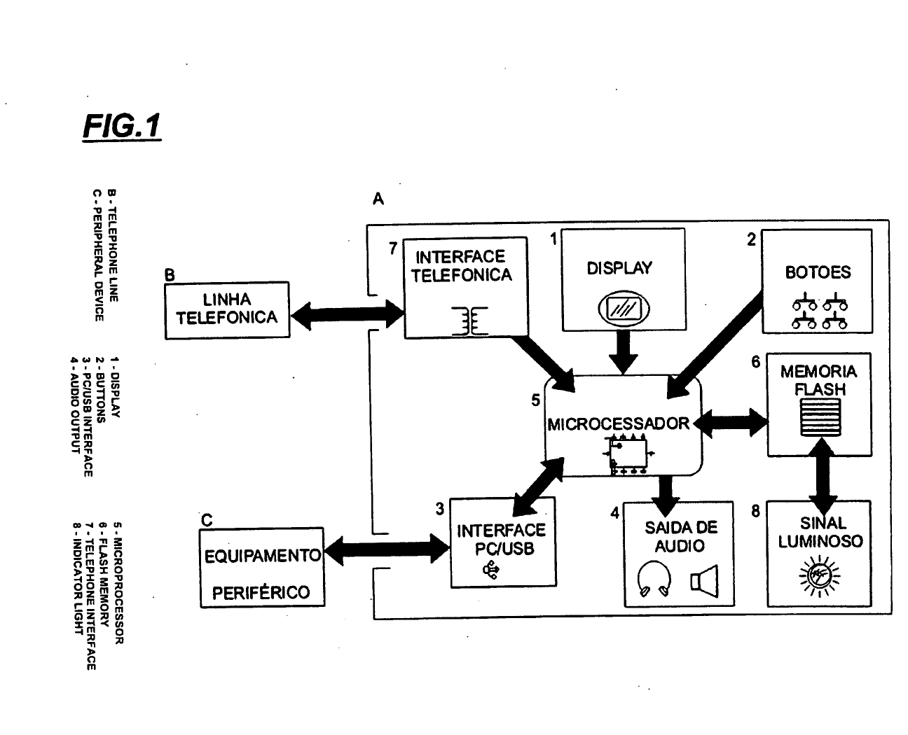

The general constructive concept of a telephone apparatus with the phone call recording device is illustrated in FIG. 1, having the following components:
Telephone apparatus (A): the device now claimed can be installed in all types of telephone apparatus, among them we can mention:
a.1) Calls identifier;
a.2) Fixed telephone with mono-phone (A1);
a.3) Telephone with call identifier;
a.4) Head set.
Display (1): it has as function to inform the status of the phone line, such as: time of recording of the dialed number, received number, the presence of a phone line and full recording memory;
Buttons (2): among the several buttons in a telephone apparatus, there is the on button (2a), or play and off (2b), or stop, whose function is to activate or to interrupt the audio (4) of the device respectively, to hear the recordings directly from the telephone apparatus (A) using an earphone or even hands free, if such function is provided by the apparatus;
USB interface (3): its function is to provide the best communication between the apparatus and a peripheral device (C) for storage and/or subsequent playing of the recordings saved in flash memory (6), where such device can be a computer; an audio player, a DVD-player, etc. This connection component is only used when it is necessary to save the recordings and to liberate space in the flash memory (6) inside the apparel (A). We must highlight this type of recording device inside the telephone apparatus (A) does not require a direct connection to a peripheral device (C) to be in operational condition;
Audio outputs (4): audio analogical output to hear the files directly from the telephone apparatus (A), using an earphone or hands free function;
Microprocessor (5): being the “core” of the invention, it has as function to control all components and linked interfaces, mainly: display (1); buttons (2); USB interface (3); audio output (4); and flash memory (6), where this microprocessor (5) digitalizes the audio and organizes it inside the mentioned flash memory (6);
Flash Memory (6): stores the audio files of the phone calls—the files are not lost even if the telephone apparatus (A) has no battery. At its turn, the files recorded in this memory are in “wave” or similar format;
Telephone interface (7): has as function to prepare the audio signal and to inform the microprocessor (5) the start and end of each phone call.
Indicator light (8): usually as a blinking lamp, it indicates the full capacity of recording storage in the flash memory (6), warning the user to the need of transferring the recorded data to liberate the memory for storing new recordings.

After having defined the functionality of the recording device now claimed, we, start describing its functional concept, which can be translated by the following logical order of actions:

1) To put the batteries inside the telephone apparatus (A)—e.g. two AA 1.5V batteries;

2) To connect the telephone apparatus (A) to a phone line (B) line or extension line;

3) To record the phone call, which happens whenever the telephone apparatus (A) starts a call, it is to say, when it receives or send a call. When receiving or sending a phone call the telephone interface (7) detects the audio signal and sends it to the microprocessor (5), which at its turn creates a recording file in the flash memory (6), which at its turn starts digitalizing the audio signal from this telephone interface (7) and stores it inside. At the end of the call the microprocessor (5) closes the recording file and this is saved in the flash memory (5) in “wave” or similar format.

4) Playing the recordings: due to the use of a volatile memory, or flash memory (6), the recordings can be heard or played through the following ways:

4.1) Directly from the telephone apparatus (A) pressing the on button (2a), also called play, where to hear the recording the user uses a peripheral device, such as an earphone or head set connected to the audio output (4);

4.2) Entering a code that allows to hear the recordings from the telephone apparatus (A) using a mono-phone (A1);

5) Transfer of the recordings: usually this operation occurs when the indicator light (8) turns on, warning the need of emptying the flash memory (6). To get it the telephone apparatus (A), through the USB interface (3), is connected to the peripheral device (C), such as a computer, which receives in the hard disk the recordings originally stored in the flash memory (6). Afterwards and eventually the files may be saved in physical media (CD). We must highlight the peripheral device (C) should have an audio player software to allow playing the recordings.

The petitioner also highlights the realization forms revealed by the detailed description of the present invention are provided only as an example, being its constructive concept may receive changes, modifications and variations that may be performed to other particular realization forms by skilled technicians without diverging from the scope of the patent of invention, which is exclusively defined in the Claims section.

We can see for all described and illustrated that the “PHONE CALL RECORDING DEVICE TO TELEPHONE APPARATUS WITH USB CONNECTION” now claimed accomplishes the rules that govern the patent of invention according to the Law of Industrial Property, deserving as consequence the respective privilege.

1) “PHONE CALL RECORDING DEVICE TO TELEPHONE APPARATUS WITH USB CONNECTION”, where a telephone apparatus (A) with a mono-phone (A1) connected to a telephone line (B) presents its constructive concept characterized by the introduction of a call recording device composed by a main component microprocessor (5), which is connected to peripheral devices display (1); a set of buttons (2), mainly on (2a) and off (2b); an USB interface (3); an audio output (4); a flash memory (6); a telephone interface (7); and also an indicator light (8), where this device may be connected to the telephone apparatus (A) as a peripheral device or also as integral part of its construction;

2) “PHONE CALL RECORDING DEVICE TO TELEPHONE APPARATUS WITH USB CONNECTION”, in accordance with claim 1, where the recording device is characterized by being applicable to all types of telephone apparatus (A), such as: a call identifier; a fixed telephone with mono-phone (A1); a telephone with call identifier; and a Head Set;

3) “PHONE CALL RECORDING DEVICE TO TELEPHONE APPARATUS WITH USB CONNECTION”, in accordance with claim 1, where the display (1) is characterized by indicating the recording time; sent number, received number, existence of connected phone line and status of the recording memory;

4) “PHONE CALL RECORDING DEVICE TO TELEPHONE APPARATUS WITH USB CONNECTION”, in accordance with claim 1, where the on (2a) and off (2b) buttons are characterized by starting or ending the audio (4) recording;

5) “PHONE CALL RECORDING DEVICE TO TELEPHONE APPARATUS WITH USB CONNECTION”, in accordance with claim 1, where the USB interface is characterized (3) by providing the communication between the telephone apparatus (A) and a peripheral device (C) with transfer of data from the flash memory (5);

6) “PHONE CALL RECORDING DEVICE TO TELEPHONE APPARATUS WITH USB CONNECTION”, in accordance with claim 1, where the audio output (4) is characterized by being an analogical output to directly hear the audio files through the telephone apparatus (A), by an earphone or hands free function;

7) “PHONE CALL RECORDING DEVICE TO TELEPHONE APPARATUS WITH USB CONNECTION”, in accordance with claim 1, where the microprocessor (5) is characterized by controlling all components and interfaces linked to it, mainly the components: display (1); buttons (2); USB interface (3); audio output (4); and flash memory (6), where this microprocessor (5) digitalizes the audio signal and organizes it inside the flash memory (6);

8) “PHONE CALL RECORDING DEVICE TO TELEPHONE APPARATUS WITH USB CONNECTION”, in accordance with claim 1, where the flash memory (6) is characterized by storing the audio files of the phone calls;

9) “PHONE CALL RECORDING DEVICE TO TELEPHONE APPARATUS WITH USB CONNECTION”, in accordance with claim 8, where the storage of the recording files is characterized by being in the “wave” or similar format;

10) “PHONE CALL RECORDING DEVICE TO TELEPHONE APPARATUS WITH USB CONNECTION”, in accordance with claim 8, where the storage of the recording files is characterized by being saved in the telephone apparatus (A) even without energy supply;

11) “PHONE CALL RECORDING DEVICE TO TELEPHONE APPARATUS WITH USB CONNECTION”, in accordance with claim 1, where the telephone interface (7) is characterized by preparing the audio signal and informing to the microprocessor (5) the start and end of each phone call;

12) “PHONE CALL RECORDING DEVICE TO TELEPHONE APPARATUS WITH USB CONNECTION”, in accordance with claim 1, where the indicator light (8) is characterized by indicating the full capacity of recording storage in the flash memory (6), warning the user to the need of transferring the recorded data to liberate the memory for storing new recordings;

13) “PHONE CALL RECORDING DEVICE TO TELEPHONE APPARATUS WITH USB CONNECTION”, in accordance with claim 12, where the liberation of the storage capacity of the flash memory (6) is characterized by the connection of the telephone apparatus (A) through the USB interface (3) to the peripheral device (C), where the recordings originally stored in the flash memory (6) are transferred to the hard disk of the computer.
